(19) United States
(12) Patent Application Publication
(10) Pub. No.: US 2025/0175066 A1
(43) Pub. Date: May 29, 2025

(54) RESOLVER

(71) Applicant: LTN Servotechnik GmbH, Otterfing (DE)

(72) Inventor: Adrian SCHÜCK, Warngau (DE)

(21) Appl. No.: 18/944,239

(22) Filed: Nov. 12, 2024

(30) Foreign Application Priority Data
Nov. 23, 2023 (EP) 23211749.9

(51) Int. Cl. H02K 24/00; H02K 5/02

(52) U.S. Cl. CPC H02K 24/00; H02K 5/02

(57) ABSTRACT

A resolver includes two units that are rotatable relative to one another about an axis. The resolver is adapted to determine the relative angular position between the two units. At least one of the two units includes a plurality of resolver windings and transformer windings. A first unit includes a first housing component and a second housing component, and a second unit includes a first hub component and a second hub component. The first and second housing components are coupled to one another at at least one connection point that extends in the circumferential direction. Additionally or alternatively, the first and second hub components are also coupled at at least one further connection point that extends in the circumferential direction.

### CROSS-REFERENCE TO RELATED APPLICATIONS

The present application claims priority to application Ser. No. 23/211,749.9, filed in the European Patent Office on Nov. 23, 2023, which is expressly incorporated herein in its entirety by reference thereto.

### FIELD OF THE INVENTION

The present invention relates to a resolver.

### BACKGROUND INFORMATION

In electrical engineering, a resolver is an electromagnetic transducer for converting the angular position of a rotor into an electrical variable or electrical signals. In this regard, the term resolver also includes transducers that are referred to as a synchro or rotary transformer or RVDT (rotary variable differential transformer).

A brushless resolver often has a plurality of windings arranged in one housing. These windings include resolver windings, including, or consisting of, stator windings and rotor windings, and they also include transformer windings, which are arranged on the rotor and on the stator. In order to minimize unwanted magnetic flux between the resolver windings and transformer windings, the resolver windings are located in a first distal region of the resolver, while the transformer windings are located as far away as possible, in the opposite second distal region of the resolver.

Such resolvers are usually produced in large quantities, so that simple and, if possible, fully automated production is desirable.

European Patent Document No. 1 667 313 describes a resolver that includes a one-piece rotor hub and a multi-piece stator housing, in which the rotor hub and stator housing are made of an identical material. Magnetic interferences between resolver windings and transformer windings are minimized by an additional shielding structure.

Such a configuration has disadvantages in terms of measuring accuracy and is also relatively difficult to manufacture or install.

### SUMMARY

Example embodiments of the present invention provide a resolver that has a comparatively increased measuring accuracy and can also be manufactured comparatively optimally in large quantities.

According to example embodiments, a resolver includes two units that are rotatable relative to one another about an axis. The resolver is adapted to determine the relative angular position between the two units, at least one of which has a plurality of resolver windings and transformer windings. A first unit includes a first housing component and a second housing component, and a second unit includes a first hub component and a second hub component. The first and second housing components are coupled or connected to one another at at least one connection point that extends in the circumferential direction of the first and second housing component. Additionally or alternatively, the first and second hub components are also coupled to one another at at least one further connection point that extends in the circumferential direction of the first and second hub component.

For example, the coupling between the first and second housing components or between the first and second hub components prevents axial displacement of the components coupled to one another. Thus, a relative axial displacement of the first housing component to the second housing component or a relative axial displacement of the first hub component to the second hub component is prevented.

In a further configuration, the first housing component and, additionally or alternatively, the first hub component is produced of a first material. In addition, the second housing component and, additionally or alternatively, the second hub component is produced of a second material.

For example, the first material is an amagnetic raw material, and the second material is a magnetic raw material.

In this context, a magnetic material or magnetic raw material refers, for example, to a ferromagnetic raw material that has high permeability and low remanence.

An amagnetic material or amagnetic raw material is, for example, a non-ferromagnetic raw material that is largely non-magnetizable, i.e., has low permeability and high remanence.

According to example embodiments, the coupling between the first and second housing component is formed in a torsion-proof manner or for conjoint rotation. Additionally or alternatively, also or only the coupling between the first and second hub component is formed in a torsion-proof manner or for conjoint rotation.

For example, the coupling between the first and second housing components is formed by a form-locking, force-locking, and/or material-locking connection technology. Additionally or alternatively, also or only the coupling between the first and second hub components is formed by a form-locking, force-locking, and/or material-locking connection technology.

For example, at least the first and second hub components are formed in a rotationally symmetrical manner.

According to example embodiments, the transformer windings are arranged in the region of the second housing component and the second hub component, and the resolver windings are arranged in the region of the first housing component and the first hub component.

The region of the first housing component and the first hub component should be understood as the arrangement of the resolver windings on the components themselves, or an arrangement of the resolver windings within a cavity that is formed by one or a plurality of these components. Similarly, the region of the second housing component and the second hub component should be understood as an arrangement of the transformer windings on the components themselves or an arrangement of the transformer windings within a cavity formed by these components.

In a further configuration, the housing components and the hub components are formed and arranged such that an air gap is formed between the units and at least the resolver windings and the transformer windings are shielded from all sides by the housing components and the hub components.

According to a further aspect hereof, a resolver series is provided. Accordingly, each resolver has a modular configuration and includes two components that are rotatable relative to one another about an axis. Each resolver in the series is suitable for determining the relative angular position of its two units during operation. At least one of the two units always has a plurality of resolver windings and transformer windings. The first unit always includes a first housing component and a second housing component. The second unit always includes a first hub component and a second hub component. The first and second housing components are coupled to one another at at least one connection point that extends in the circumferential direction of the first and second housing components. In addition, the first and second hub components can also be coupled to one another at at least one further connection point that extends in the circumferential direction of the first and second hub components.

Resolvers within the series are assembled according to the modular principle, in which subcomponents are selected from a range of different configurations, depending on requirements.

Further features and aspects of example embodiments of the present invention are described in more detail below with reference to the appended schematic FIGURE.

### BRIEF DESCRIPTION OF THE DRAWINGS

FIG. 1 is a longitudinal cross-sectional view of a resolver.

### DETAILED DESCRIPTION

So-called crosstalk may occur in brushless resolvers in which both transformer windings and resolver windings are arranged directly adjacent to one another within the resolver housing. In such arrangements, the electromagnetic fields of the transformer windings act as an interference on the resolver windings, resulting in a loss of measurement accuracy. By suitable material selection and configuration of the housing and hub components of the stator and rotor, a simplified production and decoupling or, for example, shielding, of the magnetic field of the transformer from the resolver windings is achieved and, thus, a reduction of crosstalk.

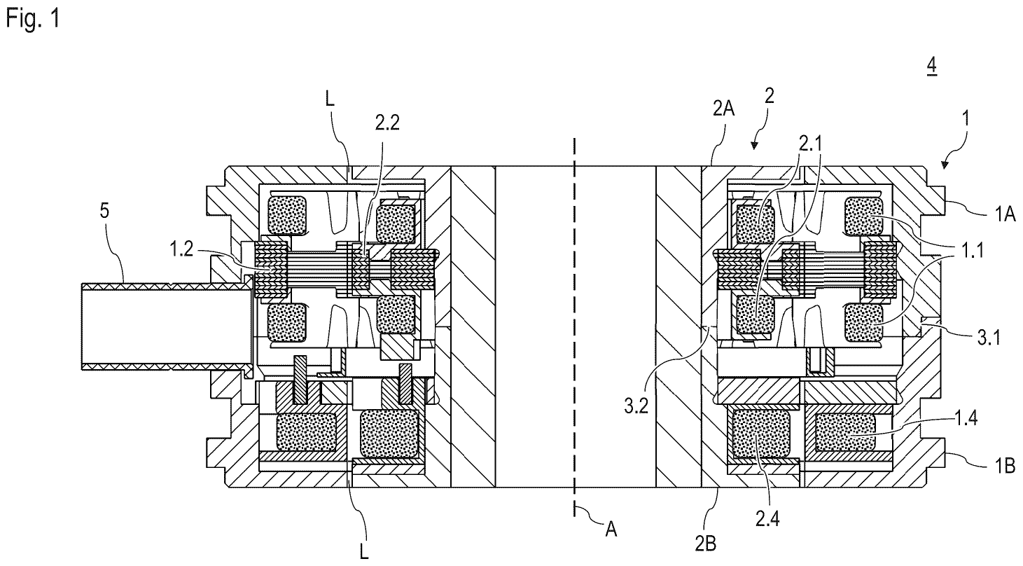

According to FIG. 1, the resolver 4 having a modular configuration includes two units that are rotatable about an axis A, e.g., a stator 1 as the first unit and a rotor 2 as the second unit. An air gap L is formed between stator 1 and rotor 2. The stator 1 has a first housing component 1A and a second housing component 1B that are coupled to one another for preventing relative axial displacement and for conjoint rotation. The first housing component 1A includes a receptacle for a laminated core 1.2. Resolver windings 1.1, for example, made of copper wire, are arranged on this laminated core 1.2 and are arranged as receiver coils. Furthermore, the stator 1 has transformer windings 1.4 that are arranged in the region of the second housing component 1B.

The relative angular position between the stator 1 and the rotor 2 can be determined using a corresponding resolver 4. For this purpose, the transformer windings 1.4 of the stator 1 are supplied with a sinusoidal alternating current, which induces an alternating voltage with a predetermined transformation ratio in the transformer windings 2.4 of the rotor 2. This alternating voltage is also applied to the resolver windings 2.1 of the rotor, so that corresponding output voltages are induced in the resolver windings 1.1 of the stator 1, which resolver windings 1.1 enclose the resolver windings 2.1 of the rotor 2. If two 90° offset resolver windings 1.1 of the stator 1 are used, two 90° phase-shifted voltage signals can be tapped, which depend on the relative angular position between stator 1 and rotor 2. The resolver 4 is thus arranged as a brushless or, for example, slip-ring-free resolver.

The electrical input or output leads from the resolver windings 1.1 and the transformer windings 1.4 are guided from the inside of the first and second housing components 1A, 1B to the outside through a bore or a guide grommet 5 partially arranged in the bore.

The rotor 2 has a first hub component 2A and a second hub component 2B, which are also coupled to one another for preventing relative axial displacement and for conjoint rotation. In the illustrated example embodiment, the first and second hub components 2A, 2B are coupled to a hollow shaft, which can be fixed for conjoint rotation, for example, to a motor shaft, the angular position of which is to be determined. The first hub component 2A includes a receptacle for a laminated core 2.2, on which the resolver windings 2.1 are arranged. Furthermore, the rotor 2 has transformer windings 2.4, which are arranged in the region of the second hub component 2B. The resolver windings 2.1 are, for example, cast together with the laminated core 2.2, utilizing a casting compound.

Instead of the laminated core 1.2 and the laminated core 2.2, alternative subcomponents can also be used, which favor the bundling of electromagnetic waves.

The coupling between the first housing component 1A and the second housing component 1B and/or between the first hub component 2A and the second hub component 2B is achieved, for example, by a form-locking and force-locking connection technique. For example, the coupling of the housing components 1A, 1B and/or the coupling of the hub components 2A, 2B uses a material-locking connection technique, for example, by laser welding or bonding.

The resolver 4 illustrated in FIG. 1 is, for example, a resolver having a modular configuration, i.e., it can be assembled and produced according to the modular principle. Almost every subcomponent of the resolver 4 is available in different configurations, in which all configurations of a subcomponent do not exceed a predefined installation space and comply with further standards. For example, the resolver windings 1.1, 1.2 may include configurations with different winding schemes.

Furthermore, by targeted selection of the configuration of individual subcomponents, synergetic effects can be achieved. For example, the first housing component 1A and the second housing component 1B may be made of different materials, and the first hub component 2A and the second hub component 2B may be made of different materials. In this manner, the propagation of the magnetic flux emanating from the current-carrying transformer windings 1.4 and 2.4 can be influenced within the resolver 4 in a targeted manner.

As illustrated in FIG. 1, the first housing component 1A and the first hub component 2A include, or consist of, an identical, amagnetic, i.e., non-magnetic, raw material. Suitable materials include, for example, amagnetic steels, aluminum, aluminum alloys, plastics, etc.

The second housing component 1B and the second hub component 2B are made of an identical raw material, which is magnetic. Magnetic steels, for example, are suitable for this purpose.

With this configuration, the magnetic field of the transformer remains primarily in the region of the transformer windings 1.4, 2.4, since it is, e.g., coupled into the magnetic second housing component 1B and the magnetic second hub component 2B. The amagnetic first housing component 1A and the amagnetic first hub component 2A conduct the magnetic flux of the magnetic field of the transformer hardly or not at all, whereby this part of the resolver 4, with the resolver windings 1.1, 1.2, is magnetically decoupled. In this manner, an additional shielding component between the transformer windings 1.4, 2.4 and the resolver windings 1.1, 2.1 can be dispensed with.

The housing components 1A, 1B and the hub components 2A, 2B shield the resolver windings 1.1, 2.1 or, for example, the transformer windings 1.4, 2.4 so that the inside of the resolver 4 is protected against contamination from all sides.

In the illustrated example embodiment, the housing components 1A, 1B and/or the hub components 2A, 2B are largely formed in a rotationally symmetrical manner and largely have an identical longitudinal extension in the axial direction with respect to the axis A. This provides for the use of semi-finished products or blanks for these subcomponents, in which the final finished part is only produced during final processing by forming the subcomponent-specific features. In this manner, either a first housing component 1A or a second housing component 1B can be produced from a corresponding semi-finished product.

Alternatively, the first housing component 1A and the first hub component 2A may be made of an amagnetic raw material, and the second housing component 1B and the second hub component 2B may be made of a magnetic raw material. In this configuration, the resolver windings 1.1, 2.1 are primarily protected against external interfering magnetic fields. In this alternative arrangement, an external interfering magnetic field couples into the second housing component 1B and the second hub component 2B and the magnetic flux remains therein.

The resolvers described herein are able to be manufactured and assembled in a standardized manner within a series, even if individual subcomponents of the finished resolvers are not identical.

What is claimed is:

1. A modular resolver, comprising:
a first unit and a second unit that are rotatable relative to one another about an axis, the resolver adapted to determine a relative angular position between the first unit and the second unit;
wherein the first unit and/or the second unit includes resolver windings and transformer windings;
wherein the first unit includes a first housing component and a second housing component;
wherein the second unit includes a first hub component and a second hub component;
wherein the first and second housing components are coupled at at least one connection point that extends in a circumferential direction and/or the first and second hub components are coupled at at least one further connection point that extends in the circumferential direction.

2. The resolver according to claim 1, wherein the first housing component and/or the first hub component is formed of a first material, and the second housing component and/or the second hub component is formed of a second material.

3. The resolver according to claim 2, wherein the first material includes an amagnetic raw material, and the second material includes a magnetic raw material.

4. The resolver according to claim 1, wherein the first and second housing components are coupled together in a torsion-proof manner, and/or the first and second hub components are coupled together in a torsion-proof manner.

5. The resolver according to claim 1, wherein the first and second housing components are coupled together by a torsion-proof coupling, and/or the first and second hub components are coupled together by a torsion-proof coupling.

6. The resolver according to claim 1, wherein the first and second housing components are coupled together in a form-locking, force-locking, and/or material-locking manner and/or the first and second hub components are coupled together in a form-locking, force-locking, and/or material-locking manner.

7. The resolver according to claim 1, wherein the first and second housing components are coupled together by a form-locking, force-locking, and/or material-locking coupling, and/or the first and second hub components are coupled together by a form-locking, force-locking, and/or material-locking coupling.

8. The resolver according to claim 1, wherein the first and second hub components are rotationally symmetric.

9. The resolver according to claim 1, wherein the transformer windings are arranged in a region of the second housing component and the second hub component, and the resolver windings are arranged in a region of the first housing component and the first hub component.

10. The resolver according to claim 1, wherein the housing components and hub components are arranged such that an air gap is located between the first and second units, and the resolver windings and the transformer windings are shielded from all sides by the housing components and the hub components.

11. The resolver according to claim 1, wherein an air gap is arranged between the first and second unit.

12. The resolver according to claim 1, wherein the resolver windings and the transformer windings are shielded from all sides by the housing components and the hub components.

13. The resolver according to claim 1, wherein the first unit is arranged as a stator, and the second unit is arranged as a rotor.

14. The resolver according to claim 1, wherein the first and second hub components are coupled to a hollow shaft adapted to be rotationally fixed to a motor shaft.

15. The resolver according to claim 1, wherein the first and second housing components are welded, laser-welded, and/or bonded to each other, and/or the first and second hub components are welded, laser-welded, and/or bonded to each other.

16. The resolver according to claim 1, wherein the first housing component and the second housing component are formed of different materials, and the first hub component and the second hub component are formed of different materials.

17. The resolver according to claim 1, wherein the first housing component and the first hub component are formed of the same material, and the second housing component and the second hub component are formed of the same material.

18. The resolver according to claim 17, wherein the first housing component and the first hub component are formed of an amagnetic material, and the second housing component and the second hub component are formed of a magnetic material.

19. The resolver according to claim 18, wherein the amagnetic material includes an amagnetic steel, aluminum, an aluminum alloy and/or a plastic, and the magnetic material includes a magnetic steel.

20. The resolver according to claim 1, wherein the first and second housing components and/or the first and second hub components have substantially the same longitudinal extension in an axial direction with respect to the axis.
